(19) United States
(12) Patent Application Publication
(10) Pub. No.: US 2014/0367209 A1
(43) Pub. Date: Dec. 18, 2014

(54) WHEEL BRAKE FOR AN AIRCRAFT, IN PARTICULAR FOR A HELICOPTER

(71) Applicant: MESSIER-BUGATTI-DOWTY, Velizy Villacoublay (FR)

(72) Inventors: Xavier DELAYRE, VELIZY-VILLACOUBLAY (FR); Jérémy HARDY, VELIZY-VILLACOUBLAY (FR)

(73) Assignee: MESSIER-BUGATTI-DOWTY, VELIZY VILLACOUBLAY (FR)

(21) Appl. No.: 14/305,929

(22) Filed: Jun. 16, 2014

(30) Foreign Application Priority Data
Jun. 17, 2013 (FR) 13 55666

(51) Int. Cl. F16D 65/095; B64C 25/44

(52) U.S. Cl. CPC F16D 65/095; B64C 25/44
USPC 188/73.31

(57) ABSTRACT

The invention relates to a brake for an aircraft wheel comprising firstly calipers with an outer jaw (103) receiving a stationary brake pad (108) and an inner jaw that is movable under drive from the braking actuator (105) and that receives a movable brake pad (107), and secondly a disk (109) that extends between the brake pads and that includes means (110) for constraining it to move in rotation with the wheel; at least one of the brake pads includes a protrusion (120) projecting from a rear face of the pad to be received in a matching receptacle (123) of the associated jaw and serving both to position the pad on the jaw and to transmit braking forces from the stationary pad to the associated jaw.

The invention relates to a wheel brake for an aircraft, in particular for a helicopter.

### TECHNOLOGICAL BACKGROUND OF THE INVENTION

On aircraft of a certain size, it is common practice to use brakes comprising a stack of disks, half of which are stators and the other half of which are rotors that rotate together with the wheel. Brake actuators serve to press the disks against one another in order to generate a braking torque that opposes free rotation of the wheel on its axle.

For aircraft of smaller size, it is known to use a brake having a single disk that rotates with the wheel, the disk being associated with calipers that are placed astride the disk and that have jaws receiving two brake pads, one of which is movably mounted in order to be capable of clamping the disk between the two pads under drive from a braking actuator. In order to minimize the overall size of the brake, the calipers are placed astride the disk on its inside. Nevertheless, in that type of brake, the pads are held against the two jaws of the calipers via their ends, thereby requiring the jaw to be of a certain size in the transverse direction, even though it needs to pass through the inside of the disk while the brake is being mounted. Nevertheless, in particularly demanding applications, where the diameter of the central orifice in the disk is small, this transverse size makes it difficult to mount the brake, or makes it necessary to use brake pads of small surface area.

### OBJECT OF THE INVENTION

An object of the invention is to provide a brake with calipers that are mounted through the inside of the disk and that is adapted to using disks of small diameter.

### SUMMARY OF THE INVENTION

In order to achieve this object, the invention provides a brake for an aircraft wheel comprising firstly calipers with an outer jaw receiving a stationary brake pad and an inner jaw that is movable under drive from a braking actuator and that receives a movable brake pad, and secondly a disk that extends between the brake pads and that includes means for constraining it to move in rotation with the wheel. According to the invention, at least one of the brake pads includes a protrusion projecting from a rear face of the pad to be received in a matching receptacle of the associated jaw and serving both to position the pad on the jaw and to transmit braking forces from the stationary pad to the associated jaw.

It thus becomes possible to limit the transverse size of the stationary pad brake and of the associated jaw, while ensuring that the brake pad is properly positioned and that braking forces are transmitted. It is thus possible to use the calipers with disks of smaller size, while still allowing the outer jaw to pass through the inside of the disk.

### DESCRIPTION OF THE FIGURES

The invention can be better understood in the light of the following description of a particular embodiment of the invention, given with reference to the figures of the accompanying drawings, in which:

FIG. 1 is a perspective view of a brake with its calipers and its disk in place on helicopter landing gear, seen from the disk side, the wheel being omitted for greater clarity;

FIG. 2 is a perspective view of the FIG. 1 brake seen from behind;

FIG. 3 is a side view of the FIG. 1 calipers;

FIG. 4 is a face view of the FIG. 1 calipers in section on line D-D of FIG. 3;

FIG. 5 is a side view of the FIG. 1 brake partially in section through the stationary brake pad; and

FIG. 6 is a view analogous to that of FIG. 5 in a second particular embodiment of the invention.

### DETAILED DESCRIPTION OF AN EMBODIMENT OF THE INVENTION

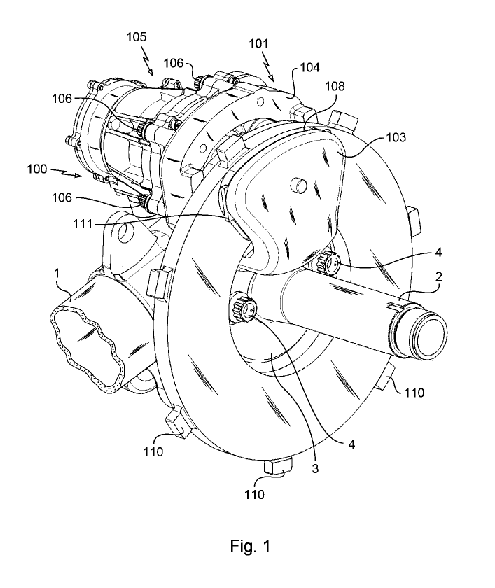

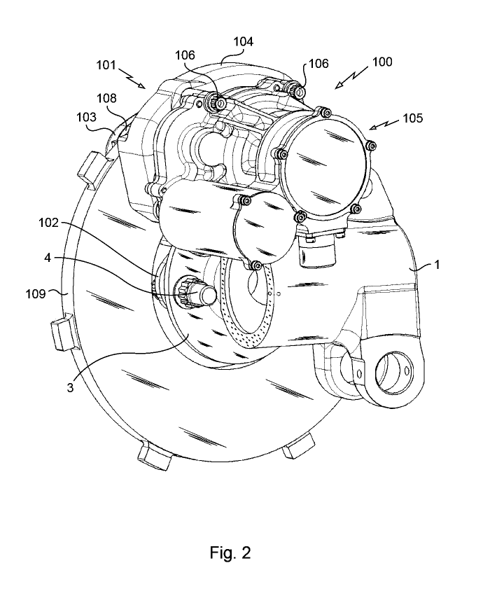

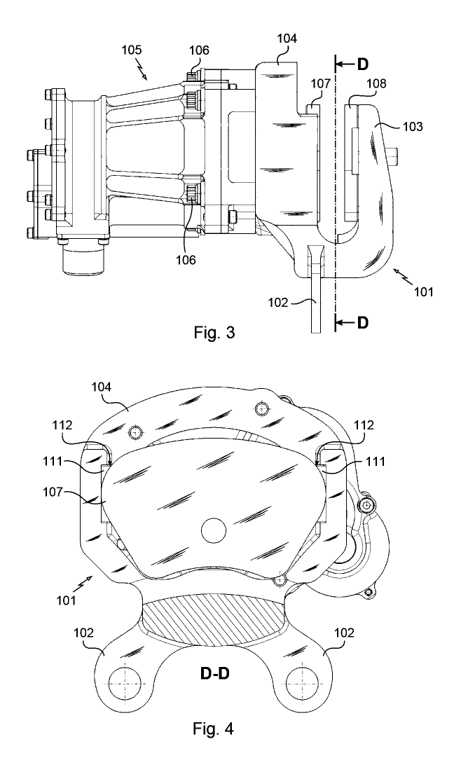

With reference to FIGS. 1 to 4, the brake 100 of the invention is for installing on aircraft landing gear, and in the figures there can be seen the bottom arm 1 of the landing gear that carries an axle 2. The axle 2 has a collar 3 on which the brake is fitted by means of two bolts 4.

The brake 100 has calipers 101 having two lugs 102 enabling the brake to be fastened to the collar 3. The calipers 101 have an outer jaw 103 and a support 104 that receives a brake actuator 105, in this example an electromechanical actuator, that is fitted on the support 104 by means of screws 106.

The brake actuator 105 has a pusher, at the end of which a movable internal jaw (not shown) receives a movable brake pad 107 that is pushed by the pusher to approach a stationary brake pad 108 carried by the outer jaw 103. A disk 109 extends between the brake pads 107 and 108 so as to be capable of being clamped between the pads under drive from the actuator 105. The disk has tenons 110 that are received in mortises of matching shape in the rim of the wheel so as to be constrained to move in rotation therewith, while being free to move axially. The disk is thus said to be floatingly mounted.

In this example, the brake pads 107 and 108 are identical in shape and have spacers 111 that project laterally from the pads in order to be received in corresponding housings 112 in the associated jaw (visible in FIG. 4). Lateral braking forces are transmitted by the spacers 111 from the movable pad 107 to the support 104 such that the actuator 105 is subjected to axial braking forces only.

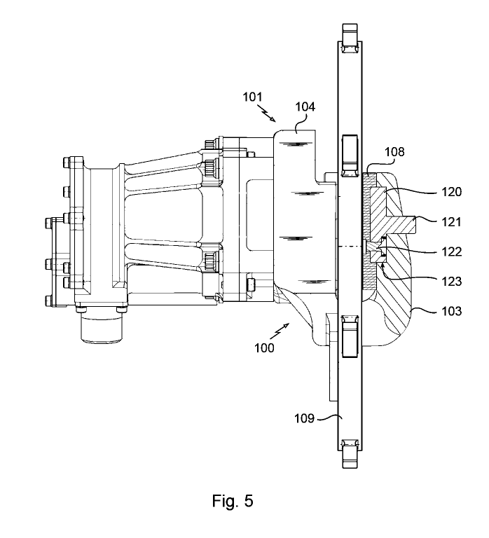

In the invention, and as can be seen more specifically in FIG. 5, the outer jaw 103 receives a central peg 120 that is received half and half between the outer jaw 103 and the stationary pad 108. Braking forces are transmitted by the central peg 120 from the stationary pad 108 to the outer jaw 103. The central peg 120 forms a protrusion projecting from a rear face of the pad 108 to be received in a receptacle 123 that is formed directly in the outer jaw 103 in this example.

The central peg 120 is provided with a centering stud 121 that extends through an open orifice in the outer jaw 103 so as to project out therefrom, thereby making it possible to verify visually that the central peg 120 is present.

In addition, a fastener pin 122 extends between the stationary pad 108 and the central peg 120 in order to secure these two elements together. For this purpose, the central peg 120 and the stationary pad 108 presents facing recesses for receiving said fastener pin 122. Since the brake pads 107 and 108 are identical, the recess in question can be seen in the movable pad 107 as shown in FIG. 4. It should be observed that the stationary pad 108 also has spacers 111, that are of no use in this example.

The use of a central peg 120 for transmitting forces between the stationary pad 108 and the outer jaw 103 serves to reduce the lateral size of the outer jaw 103, since there is no longer any need for it to present lateral extensions for receiving housings 112 suitable for receiving the spacers 107. Thus, and as can be seen in FIG. 1, the outline of the outer jaw 103 may follow exactly the outline of the stationary pad 108 so as to provide it with a sufficient reaction surface, while limiting the lateral size of the outer jaw 103. It can also be seen that the spacers 111 of the stationary pad 108 project (a little) from the outer jaw 103.

As a result, the lateral size of the outer jaw 103 is limited to that which is strictly necessary, thereby enabling it to pass through the central orifice of a disk of smaller size than the size of the disk commonly used in this kind of brake.

In order to disassemble such a brake, the wheel is removed first, and then the bolts 4 that hold the calipers on the landing gear are loosened. The calipers are removed together with the disk 109, and then once they have been taken away from the landing gear, the disk is separated from the calipers by causing the outer jaw 103 to pass through the central orifice in the disk 109. By limiting the lateral size of the outer jaw 103 it becomes possible to pass it through a central orifice of small size.

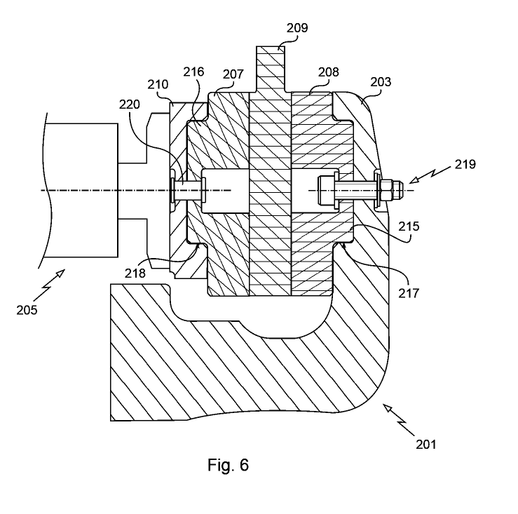

In a second embodiment as shown in FIG. 6, where references to elements that are identical have 100 added thereto, the brake pads 207, 208 both present central protrusions 215, 216 formed integrally with the pads and projecting from the rear faces of the pads in order to be received in receptacles 217, 218 formed respectively in the outer jaw 203 and the inner jaw 210.

The stationary pad 208 is secured to the outer jaw 203 by means of a bolt 219, while the movable pad 207 is secured on the inner jaw 210 by means of a fastener pin 220.

Thus, for both brake pads, lateral forces are transmitted by the protrusions, such that the lateral spacers are not needed.

1. A brake for an aircraft wheel comprising firstly calipers with an outer jaw (103; 203) receiving a stationary brake pad (108; 208) and an inner jaw that is movable (210) under drive from a braking actuator (105; 205) and that receives a movable brake pad (107), and secondly a disk (109; 209) that extends between the brake pads and that includes means (110) for constraining it to move in rotation with the wheel, the brake being characterized in that at least one of the brake pads includes a protrusion (120; 215; 216) projecting from a rear face of the pad to be received in a matching receptacle (123; 217; 218) of the associated jaw and serving both to position the pad on the jaw and to transmit braking forces from the stationary pad to the associated jaw.

2. A brake according to claim 1, wherein the receptacle is made directly in the jaw.

3. A brake according to claim 1, wherein the protrusion (215; 216) is made integrally with the brake pad (208, 207).

4. A brake according to claim 1, wherein the protrusion (120) is made by means of a central peg (120) received in an open housing in the rear face of the brake pad so as to project therefrom and extend half and half in the jaw and in the brake pad.

5. A brake according to claim 4, wherein the central peg (120) includes a centering stud (121) that extends through an open orifice of the outer jaw (103) to project externally therefrom.

6. A brake according to claim 4, wherein the central peg (120) and the stationary brake pad (108) are secured to each other by means of a fastener pin (122).

7. A brake according to claim 4, wherein the stationary brake pad (108) and the outer jaw (103) have outlines that are substantially identical.
